(19) United States
(12) Patent Application Publication
(10) Pub. No.: US 2007/0277409 A1
(43) Pub. Date: Dec. 6, 2007

(54) Correction tape device incorporated with a decoration piece

(75) Inventor: Ming-Hua Yen, Shulin City (TW)

Correspondence Address: John G. Chupa;Law Offices of John Chupa & Associates, P.C., 28535 Orchard Lake Road,, Suite 50, Farmington Hills, MI, 48334, US

(73) Assignee: Mcaide Enterprise Co., Ltd.

(21) Appl. No.: 11/643,276

(22) Filed: Dec. 21, 2006

(30) Foreign Application Priority Data
Jun. 1, 2006 (TW) 095209492

(51) Int. Cl. G04B 45/00

(52) U.S. Cl. 40/468

(57) ABSTRACT

The present invention discloses a correction tape device incorporated with a decoration device, comprising a body one peripheral surface of which has a protruding rim inside which a recess 14 is defined; a cover which is a transparent body with identical dimension and shape to those of the recess and can be positioned and connected with the recess; therefore a decoration piece with images on its surface may be positioned in the recess, and a cover is positioned upon the decoration piece and connected with the recess such that the decoration piece is clamped between the recess and the cover.

### FIELD OF THE INVENTION

The present invention relates to a correction tape device and in particular to a correction tape device which is incorporated with a decoration device so as to increase its added value.

### BACKGROUND OF THE INVENTION

A correction tape device is commonly used nowadays, especially to those who constantly write, drawing professionals, and students; it is one of their necessities, so to speak. A correction tape device can cover those areas which are intended not to be disclosed. Since the correction tape device can be used quickly and conveniently without harming paper, unlike the traditional rubber. Therefore, the correction tape device has been sold in almost all stationery stores and bookstores.

A conventional correction tape basically comprises a body and a front opening (or a tape opening). The body has a tape-feeding and a tape-rolling mechanism therein and the correction tape passes through the tape-guiding section to the opening. Consequently, when a user uses the correction tape device, the end of the tape-guiding section is pressed against the intended area to cover it accordingly.

The surface of the correction tape device is generally printed with images such as words, figures, or patterns, for marking or decorating. Conventional method uses the offset printing or screen printing to print images on the surface of the body. Alternatively, companies print images on a paper, a sticker for example, and stick it on the surface. Although the latter method can attach images on the body of the correction tape device, the images have been stuck before leaving for the market and thus consumers cannot do anything to reflect their personal tastes or styles. Consequently, if consumers can put the images they love on the stationery they use, the correction tape device for example, the stationery would become a unique product of its kind.

### SUMMARY OF THE INVENTION

To meet such a demand, the applicant having a long time experience in designing, production, and marketing of stationeries proposes the present invention, a correction tape device incorporated with a decoration device, as a result of numerous trials and experiments.

An object of the present invention is to provide a correction tape device incorporated with a decoration device, comprising a body at least one peripheral surface of which has a protruding rim inside which a recess is defined; a cover which is a transparent body with identical dimension and shape to those of the recess and can be positioned and connected with the recess; therefore a decoration piece with images on its surface may be positioned in the recess, and the cover is positioned upon the decoration piece and connected with the recess such that the decoration piece is clamped between the recess and the cover.

Another object of the present invention is to provide a correction tape device incorporated with a decoration device, wherein the shape of the recess may or may not be identical to that of the body.

Yet another of the present invention is to provide a correction tape device incorporated with a decoration device, wherein the boundary between the recess and the protruding rim is formed to have at least two engaged slots and the cover periphery corresponding to the engaged slots is disposed with catch edges for the engaging and securing the body and the cover.

Still yet another object of the present invention is to provide a correction tape device incorporated with a decoration device, wherein the decoration piece is a paper or plastic film and the image is words, patterns, or figures.

Still another object of the present invention is to provide a correction tape device incorporated with a decoration device, comprising a body at least one peripheral surface of which has a protruding rim inside which a recess is defined; a ring cover which is a ring body with a hollow interior and connected to the protruding rim; therefore a decoration piece with images on its surface may be positioned in the recess, and the ring cover is positioned upon the protruding rim such that the decoration piece is clamped between the recess and the ring cover.

Still yet another object of the present invention is to provide a correction tape device incorporated with a decoration device, wherein the top of the protruding rim is formed with a plurality of engaged holes and the bottom of the ring cover corresponding to the engaged holes are protrudingly disposed with engaged tenons for the engaging and securing the body and the ring cover.

Still yet another object of the present invention is to provide a correction tape device incorporated with a decoration device, wherein a transparent cover is provided between the ring cover and the decoration piece.

### BRIEF DESCRIPTION OF THE DRAWINGS

The present invention can be more fully understood by reference to the following description and accompanying drawings, in which:

FIG. 1 schematically illustrates a perspective view of a preferred embodiment of a correction tape device according to the present invention;

FIG. 2 schematically illustrates a perspective assembly view of FIG. 1;

FIG. 3 schematically illustrates an exploded perspective view of another preferred embodiment of a correction tape device according to the present invention;

FIG. 4 schematically illustrates an exploded perspective view of yet another preferred embodiment of a correction tape device according to the present invention; and

FIG. 5 schematically illustrates a perspective assembly view of FIG. 4.

### DETAILED DESCRIPTION OF THE PREFERRED EMBODIMENTS

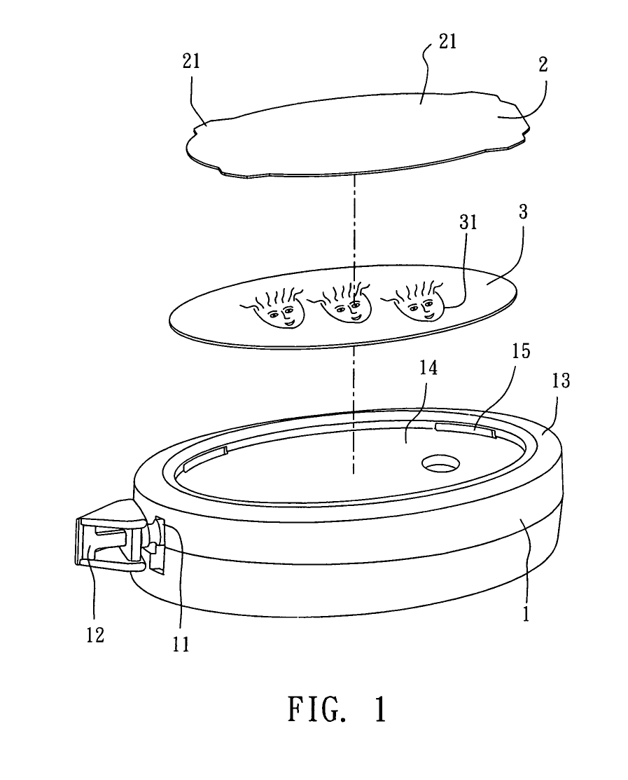

With reference to FIG. 1, a correction tape according to the present invention comprises a body 1 and a cover 2, wherein if the body 1 is a conventional art having a tape-feeding and tape-rolling mechanisms with a tape outlet 11 disposed on one side of the body 1. Further, a tape-guiding support 12 is secured on the tape outlet 11, and the tape passes through the tape-guiding support 12, such that the body 1 has the functions of retrieving and delivering the tape, which is a conventional art and will not be discussed furthermore.

The present invention differs from the conventional art in that at least one peripheral surface of the body 1 has a protruding rim 13 inside which a recess 14 is defined. As shown in the figure, the body 1 is an oval shape and the recess 14 has, but not limited to, the same shape. The recess 14 may also be in a different shape, but it is required to accommodate a decoration piece 3 and a cover 2 described later. To enable the recess 14 conveniently connected with the cover 2, the boundary between the recess 14 and the protruding rim 13 is formed to have at least two catch slots 15, as shown in the figures. The periphery of the recess 14 is formed to have four rectangular catch slots 15 to enhance the connection between the body 1 and the cover 2 such that the decoration piece 3 clamped therebetween will not come off.

The cover 2 is a transparent body with identical dimension and shape to those of the recess 14. In an actual embodiment, the cover 2 is preferably made of plastics, for example but not limited to PET Film. The cover 2 is formed by stamping and disposed with at least two catch edges 21 on its periphery to be retained at the catch slots 15 on the recess 14 such that the cover 2 can be secured upon the recess 14.

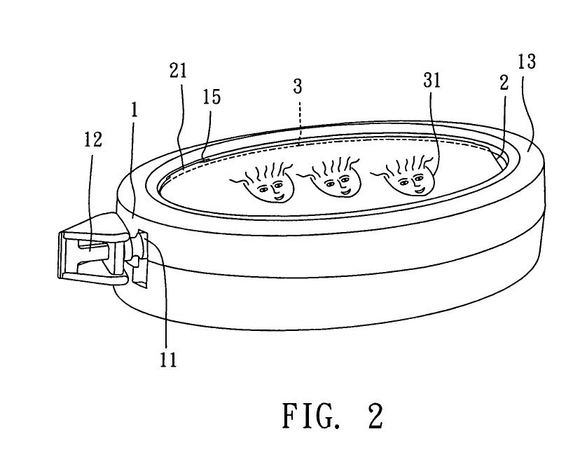

The decoration piece 3 is a sheet, paper or plastic film for example, with printed image 31, words, patterns, or figures (trade mark or written words) on its surface. The dimension and shape of the decoration piece 3 is preferably, but not limited to, identical to those of the recess 14. However, the only requirement is to be accommodated in the recess 14. Therefore, for a manufacturer, the printed image 31, trade mark and/or written words for example, is first printed on the surface of decoration piece 3, which is then positioned in the recess 14, and finally the cover 2 is positioned upon the decoration piece 3. The catch edges 21 of the cover 2 are engaged into their corresponding catch slots 15 to securingly fasten the decoration piece 3 onto the recess 14 of the body 1. The perspective view of the assembly structure is shown in FIG. 2. Users, however, can prepare their own decoration piece; photo, photo sticker, scenic photo, and so on, for example; to meet individual needs.

With reference again to FIG. 2, when consumers first obtain the present invention, they can easily separate the cover 2 and the original decoration piece 3 from the recess 14 of the body 1 simply by disengaging the catch edges 21 and the catch slots 15. Then, they can replace the original decoration piece with their chosen new decoration piece 3 after the new decoration piece 3 is being cut to a shape and dimension identical to those of the original one.

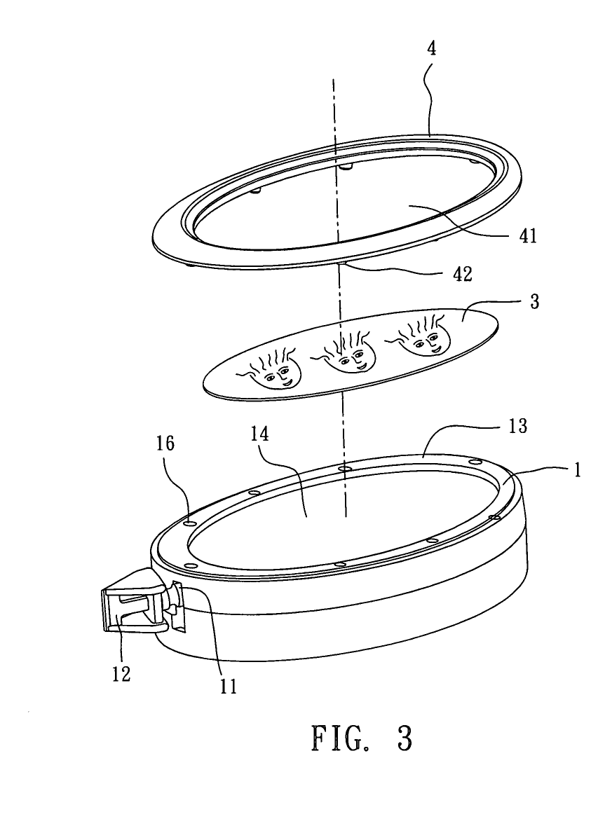

FIG. 3 schematically shows a perspective view of another embodiment of the present invention. The present embodiment uses a ring cover 4 to replace the transparent cover 2, which is different from the first embodiment. Consequently, the body 1 has at least a protruding rim 13 within which a recess 14 is defined and the top of the protruding rim 13 is formed with a plurality of engaged holes 16 to connect with the ring cover 4. The ring cover 4 is a ring body with a hollow interior 41 the peripheral dimension and shape of which are preferably identical, but not limited, to those the protruding rim 13. As shown in the figure, the ring cover 4 is an oval shape of hollow interior and its bottom corresponding to the engaged holes 16 is protrudingly disposed with engaged tenons 42. When the present embodiment according to the present invention is being assembled, the decoration piece 3 is positioned into the recess 14 and then the ring cover 4 is connected to the protruding rim 13 of the body 1, such that the lower rim of the ring body 4 may clamp the edge of the decoration piece 3 securely thereon.

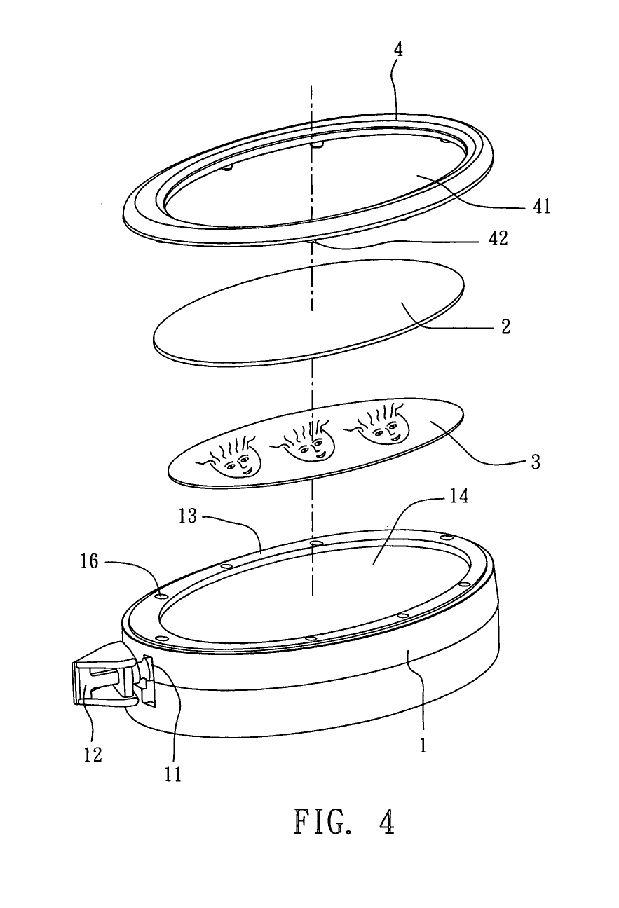

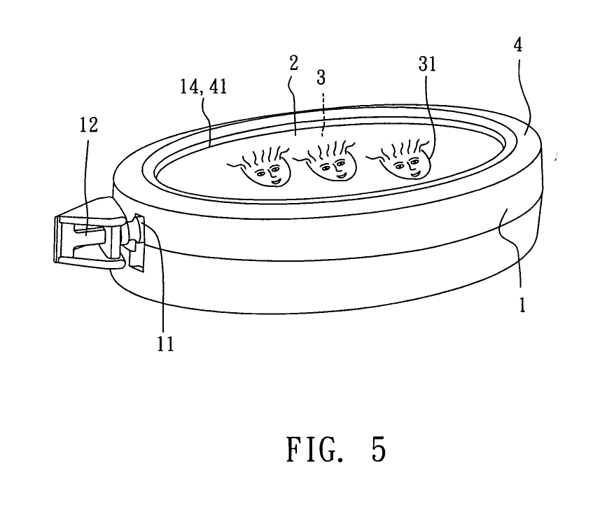

FIG. 4 schematically shows a perspective view of still another embodiment of the present invention. The present embodiment has a transparent cover 2, which is different from the second embodiment, disposed between the ring cover 4 and the decoration piece 3 to protect the decoration piece 3. FIG. 5 schematically shows the perspective assembly view of the present embodiment according to the present invention.

Consequently, with the implementation of the present invention, consumers can quickly change the decoration piece at will such that the correction tape may reflect personal characteristic or style. Also, the manufactures can be exempt from printing figures on the body and thus the cost is cut down along with a bigger business opportunity. It is therefore a win-win situation and indeed a breakthrough of its kind.

While the invention has been described with reference to the a preferred embodiment thereof, it is to be understood that modifications or variations may be easily made without departing from the spirit of this invention, which is defined by the appended claims.

What is claimed is:

1. A correction tape device incorporated with a decoration device, comprising
a body at least one peripheral surface of which has a protruding rim inside which a recess is defined;
a cover which is a transparent body with identical dimension and shape to those of the recess and can be positioned and connected with the recess;
therefore a decoration piece with images on its surface may be positioned in the recess, and the cover is positioned upon the decoration piece and connected with the recess such that the decoration piece is clamped between the recess and the cover.

2. The device as defined in claim 1, wherein the shape of the recess may or may not be identical to that of the body.

3. The device as defined in claim 1, wherein the boundary between the recess and the protruding rim is formed to have at least two engaged slots and the cover periphery corresponding to the engaged slots is disposed with catch edges for the engaging and securing the body and the cover.

4. The device as defined in claim 1, wherein the decoration piece is a paper or plastic film.

5. The device as defined in claim 1, wherein the image is words, patterns, or figures.

6. The device as defined in claim 1, wherein the image of the decoration piece is a picture prepared by a user.

7. A correction tape device incorporated with a decoration device, comprising
a body at least one peripheral surface of which has a protruding rim inside which a recess is defined;
a ring cover which is a ring body with a hollow interior and connected to the protruding rim;
therefore a decoration piece with images on its surface may be positioned in the recess, and the ring cover is positioned upon the protruding rim such that the decoration piece is clamped between the recess and the ring cover.

8. The device as defined in claim 7, wherein the top of the protruding rim is formed with a plurality of engaged holes and the bottom of the ring cover corresponding to the engaged holes are protrudingly disposed with engaged tenons for the engaging and securing the body and the ring cover.

9. The device as defined in claim 7, wherein a transparent cover is provided between the ring cover and the decoration piece.

10. The device as defined in claim 7, wherein the shape of the recess may or may not be identical to that of the body.

11. The device as defined in claim 7, wherein, the decoration piece is a paper or plastic film.

12. The device as defined in claim 7, wherein the image is words, patterns, or figures.

13. The device as defined in claim 7, wherein the image of the decoration piece is a picture prepared by a user.
